(19) United States
(12) Patent Application Publication
(10) Pub. No.: US 2023/0061919 A1
(43) Pub. Date: Mar. 2, 2023

(54) REMOTE DRIVING HANDING OVER METHOD, REMOTE DRIVING SYSTEM, AND STORAGE MEDIUM

(71) Applicant: TOYOTA JIDOSHA KABUSHIKI KAISHA, Toyota-shi, (JP)

(72) Inventors: Toru TAKASHIMA, Susono-shi (JP); Takahiro OGAWA, Okazaki-shi (JP); Kenji TADAKUMA, Toyota-shi (JP); Keisuke MIWA, Toyota-shi (JP); Shuichi TAMAGAWA, Kitanagoya-shi (JP); Takahiro OKANO, Chiryu-shi (JP); Shun OTA, Susono-shi (JP); Yuki NISHIKAWA, Susono-shi (JP)

(73) Assignee: TOYOTA JIDOSHA KABUSHIKI KAISHA, Toyota-shi (JP)

(21) Appl. No.: 17/864,771

(22) Filed: Jul. 14, 2022

(30) Foreign Application Priority Data
Aug. 31, 2021 (JP) 2021-141586

(51) Int. Cl. G05D 1/00; G06Q 10/06

(52) U.S. Cl. CPC G05D 1/0022; G06Q 10/063112; G05D 2201/0213

(57) ABSTRACT

A remote driving handing over method of a vehicle of the present disclosure, the handing over method including: acquiring a switching request; selecting a new remote operator in charge of remote driving of the vehicle, in response to the switching request; and switching a person in charge of remote driving of the vehicle from a current remote operator to the new remote operator in response to selection of the new remote operator.

### CROSS-REFERENCE TO RELATED APPLICATION

This application claims priority to Japanese Patent Application No. 2021-141586 filed on Aug. 31, 2021, incorporated herein by reference in its entirety.

### BACKGROUND

### 1. Technical Field

The present disclosure relates to a remote driving handing over method of a vehicle by a remote operator, a remote driving system capable of handing over remote driving, and a storage medium that stores a program that causes a computer to hand over remote driving.

### 2. Description of Related Art

Japanese Unexamined Patent Application Publication No. 2020-204998 (JP 2020-204998 A) discloses, when switching driving of a vehicle from autonomous driving to manual driving, a priority as a driver including not only an occupant of the own vehicle but also an occupant of another vehicle is determined, and handing over driving of the vehicle to the occupant having a high priority. At that time, according to the technique described in JP 2020-204998 A, when a driving candidate is seated in a seat other than a driver's seat of the own vehicle, or when the driving candidate is an occupant of the other vehicle, the driving candidate controls the vehicle by a remote control device.

JP 2020-204998 A discloses an embodiment that hands over driving of the vehicle from autonomous driving by an autonomous driving system to remote driving by a remote operator. In remote driving of the vehicle, there is a possibility that a preference of the occupant of the remotely driven vehicle and a driving habit of the remote operator do not match, and the occupant may feel anxiety or discomfort regarding driving of the remote operator. In such cases, it is desirable to switch the remote operator. However, there is no description in JP 2020-204998 A about handing over driving of the vehicle from remote driving by the remote operator to remote driving by another remote operator.

### SUMMARY

The present disclosure has been made in view of the above-mentioned issues. It is an object of the present disclosure to provide a technique that enables remote driving of a vehicle to be handed over to remote driving by another remote operator.

The present disclosure provides a remote driving handing over method of a vehicle. The handing over method of the present disclosure includes at least three steps. A first step is acquiring a switching request. A second step is selecting a new remote operator in charge of remote driving of the vehicle, in response to the switching request. A third step is switching a person in charge of remote driving of the vehicle from a current remote operator to the new remote operator in response to selection of the new remote operator.

In the second step, a remote operator that meets an operator condition required by an occupant of the vehicle may be selected as the new remote operator.

In this case, the new remote operator may be selected by referring to a driving characteristic database that stores a driving characteristic of each of the remote operators. The driving characteristic may include a feature amount of at least one driving operation among a steering operation, a braking operation, and an accelerating operation, or may include robustness of a driving operation regarding a communication delay.

Further, the new remote operator may be selected by referring to an evaluation database in which a result of an evaluation of each of the remote operators by each of the occupants is accumulated. When referring to the evaluation database, a remote operator having the highest evaluation by a target occupant among remote operators who have been in charge of the target occupant may be searched from the evaluation database. When there is no remote operator who has been in charge of the target occupant in the past, a similar occupant who requests an operator condition closest to the operator condition requested by the target occupant may be identified, and a remote operator having the highest evaluation by the similar occupant may be searched from the evaluation database.

Further, the new remote operator may be selected by referring to a management database that manages a working condition of each of the remote operators.

Further, in the second step, a remote operator having the highest evaluation by an entirety of users among remote operators on standby may be selected as the new remote operator.

In the first step, a switching request issued by the occupant or a switching request issued by an observer who observes driving of the current remote operator may be required. Further, a fact that a driving time or a driving distance of the current remote operator has reached a specified value may be acquired as the switching request. In addition, a switching request issued by the current remote operator may be acquired.

In the third step, the current remote operator may be switched to the new remote operator by gradually changing an operation amount of the vehicle from an operation amount by the current remote operator to an operation amount by the new remote operator. As a gradually changing process, a correction amount of the operation amount by the new remote operator may be gradually decreased, in which a difference between the operation amount by the current remote operator and the operation amount by the new remote operator when switching to the new remote operator is set as an initial value. Further, as the gradually changing process, a correction gain of the operation amount by the new remote operator may be gradually decreased, in which a ratio between the operation amount by the current remote operator and the operation amount by the new remote operator when switching to the new remote operator is set as an initial value.

Further, in the third step, an operation amount of the vehicle may be switched from an operation amount by the current remote operator to an operation amount by the new remote operator, in response to a fact that a difference between the operation amount by the new remote operator and the operation amount by the current remote operator has become a predetermined value or less.

The handing over method of the present disclosure may further include a fourth step. The fourth step is extending remote driving by the current remote operator in response to a fact that a switching condition of switching from the current remote operator to the new remote operator is not met.

The present disclosure also provides a remote driving system of a vehicle. The remote driving system of the present disclosure includes: at least one memory that stores at least one program; and at least one processor connected to the at least one memory. The at least one program is configured to cause the at least one processor to execute at least three processes. A first process is acquiring a switching request. A second process is selecting a new remote operator in charge of remote driving of the vehicle, in response to the switching request. A third process is switching a person in charge of remote driving of the vehicle from a current remote operator to the new remote operator in response to selection of the new remote operator.

Moreover, the present disclosure provides a storage medium that stores a program that causes a computer to hand over remote driving of a vehicle. The storage medium according to the present disclosure is configured to store a program that causes the computer to execute at least three processes. A first process is acquiring a switching request. A second process is selecting a new remote operator in charge of remote driving of the vehicle, in response to the switching request. A third process is switching a person in charge of remote driving of the vehicle from a current remote operator to the new remote operator in response to selection of the new remote operator.

According to the remote driving handing over method, the remote driving system, and the storage medium of the present disclosure, remote driving of the vehicle can be handed over to remote driving by the other remote operator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of a remote driving system according to an embodiment of the present disclosure;

FIG. 2 is a block diagram showing a configuration of an operator database;

FIG. 3 is a diagram for explaining an outline of a driving characteristic database;

FIG. 4 is a diagram for explaining an outline of an evaluation database;

FIG. 5 is a diagram for explaining an outline of a management database;

FIG. 6 is a diagram for explaining a correction amount gradual changing method that is one of first methods of operator switching process;

FIG. 7 is a diagram for explaining a correction gain gradual changing method that is one of the first methods of the operator switching process;

FIG. 8 is a diagram for explaining a second method of the operator switching process; and

FIG. 9 is a flowchart showing a remote driving handing over method according to the embodiment of the present disclosure.

### DETAILED DESCRIPTION OF EMBODIMENTS

Hereinafter, an embodiment of the present disclosure will be described with reference to the drawings. However, when the number, quantity, amount, range, etc. of each element are referred to in the embodiment shown below, the idea of the present disclosure is not limited to the numbers mentioned herein except when explicitly stated or when clearly specified by the number in principle. In addition, the structures and the like described in the embodiment shown below are not necessarily essential to the idea of the present disclosure, except when explicitly stated or when clearly specified in principle.

1. Configuration of Remote Driving System

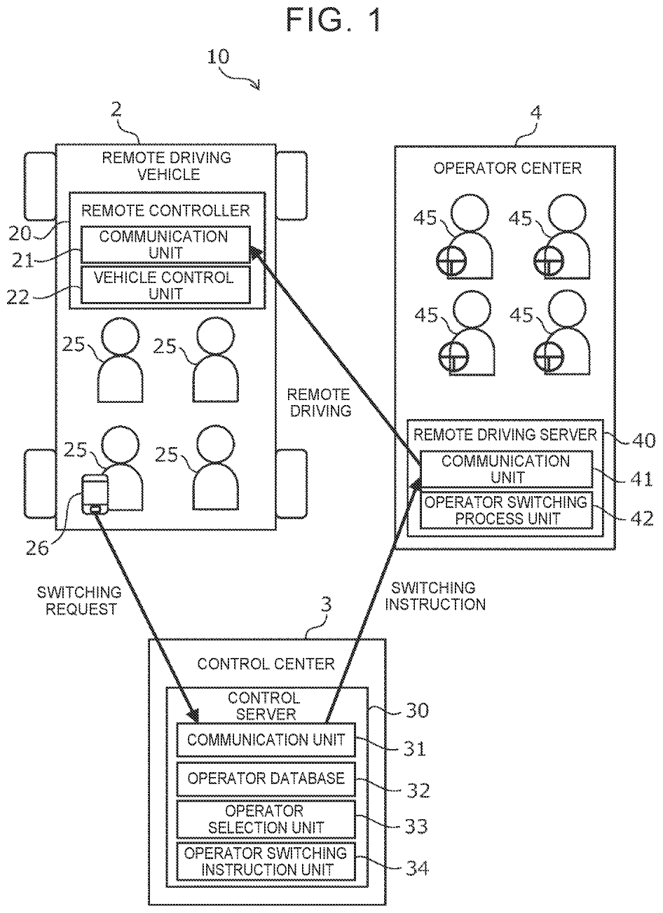

FIG. 1 is a configuration diagram of a remote driving system for a vehicle. A remote driving system 10 is a system that provides a remote driving service to a user. The user in the remote driving service is an occupant 25 of a vehicle 2 to be remotely controlled. The vehicle 2 to be remotely driven may be, for example, a privately owned vehicle, a ride-sharing vehicle in which a plurality of people ride together, or a public transportation vehicle such as a bus or a taxi.

The vehicle 2 includes a remote controller 20 for receiving remote driving. The remote controller 20 includes a processor and a memory (storage medium) connected to the processor. The memory stores a program that can be executed by the processor and various information related to the program. When the program is executed by the processor, various functions for driving the vehicle 2 by remote driving are realized in the remote controller 20.

The remote controller 20 includes a communication unit 21 that communicates with the outside using mobile communication including 4G and 5G. Further, the remote controller 20 includes a vehicle control unit 22 that controls the vehicle 2 according to a remote driving signal acquired via the communication unit 21. The remote driving signal includes an operation signal for operating a steering actuator, a braking actuator, and a drive actuator of the vehicle 2. The remote driving signal also includes an operation signal for operating safety equipment of the vehicle 2 such as a turn signal, a wiper, and a light, and comfort equipment for the occupant 25 such as an air conditioner and an audio system. The communication unit 21 and the vehicle control unit 22 are included in the functions of the remote controller 20 realized by executing the program by the processor.

In remote driving, the recognition, determination, and operation necessary for driving the vehicle 2 are performed by a remote operator 45 instead of the occupant 25. Hereinafter, the remote operator is simply referred to as an operator. The operator 45 includes a resident operator who resides in an operator center 4 that is a base for remote driving and that remotely controls the vehicle 2, and an overseas operator who accesses the operator center 4 from the outside such as a home and performs remote driving. However, the operator 45 shown in FIG. 1 is the resident operator, and the overseas operator is not shown.

The operator 45 remotely drives the vehicle 2 in a remote driver's seat. The remote driver's seat is provided with a display that outputs images and a speaker that outputs sound. The display displays, for example, an image of the space ahead of the vehicle 2 and an image of the surroundings captured by the camera of the vehicle 2. The speaker, for example, conveys the situation around the vehicle 2 collected by a microphone to the operator 45 by voice.

The remote driver's seat is provided with a steering wheel for steering operation, an accelerator pedal for acceleration operation, and a brake pedal for deceleration operation. Further, when the vehicle 2 is equipped with a transmission, the remote driver's seat may also be equipped with a lever or a switch of the transmission. In addition, an operating device for operating safety equipment of the vehicle 2 and an operating device for adjusting the setting of comfort equipment are provided in the remote driver's seat.

The remote driver's seat operated by the operator 45 is connected to a remote driving server 40. The remote driving server 40 may be installed in the operator center 4 or may be installed on the cloud. The remote driving server 40 includes a processor and a memory (storage medium) coupled to the processor. The memory stores a program that can be executed by the processor and various information related to the program. By executing the program on the processor, various functions for remote driving are realized in the remote driving server 40.

The remote driving server 40 includes a communication unit 41 that communicates with the outside via a communication network. The communication unit 41 receives image information acquired by the camera of the vehicle 2 and voice information acquired by the microphone from the remote controller 20, and transmits the remote driving signal for remote driving to the remote controller 20. Further, the communication unit 41 receives a switching instruction of the operator 45 from a control center 3 described below. The remote driving server 40 includes an operator switching process unit 42 that performs a process for changing the operator 45 in charge of remote driving. The contents of the operator switching process will be described in detail later. The communication unit 41 and the operator switching process unit 42 are included in the functions of the remote driving server 40 realized by the processor executing the program.

The control center 3 manages the operator 45 who remotely drives the vehicle 2. The control center 3 has the right to appoint the operator 45 who is in charge of remote driving of the vehicle 2. The control center 3 may be a real facility or a virtual facility on the cloud. The control center 3 is provided with a control server 30. The control server 30 includes a processor and a memory (storage medium) coupled to the processor. The memory stores a program that can be executed by the processor and various information related to the program. By executing the program on the processor, various functions for managing the operator 45 are realized in the control server 30.

The control server 30 includes a communication unit 31 that communicates with the outside via a communication network. The communication unit 31 receives the switching request in which the occupant 25 requests for the operator 45 to be switched, and transmits the switching instruction for replacing the operator 45 to the remote driving server 40. The occupant 25 can send a switching request to the control center 3 by operating a mobile terminal 26 such as a smartphone. In a dedicated application of the mobile terminal 26, an input screen of the operator conditions desired by the occupant 25 is displayed. The occupant 25 can send the switching request by selecting the operator condition in detail, or can send the switching request without selecting the operator condition.

The control server 30 further includes an operator database 32, an operator selection unit 33, and an operator switching instruction unit 34. In response to the switching request from the occupant 25, the operator selection unit 33 selects the new operator 45 in charge of remote driving of the vehicle 2 that the occupant 25 is riding. At this time, the operator selection unit 33 selects the new operator 45 with reference to the operator database 32. The operator switching instruction unit 34 transmits a switching instruction to the remote driving server 40 so that the new operator 45 selected by the operator selection unit 33 takes over the remote driving. These functions of the control server 30 are realized by the processor executing the program.

2. Operator Selection

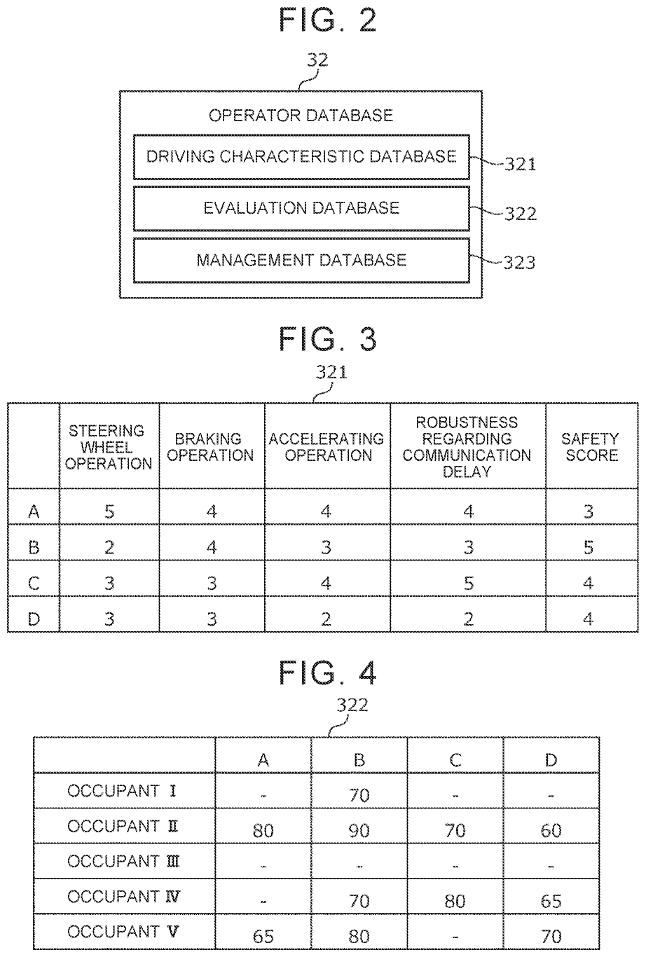

Next, a method of selecting the operator 45 in response to the switching request will be described. The operator database 32 is used to select the new operator 45. The operator database 32 is a database that manages various operator conditions referred to in the selection of the operator 45. The operator conditions include an operation history and a grade of the operator 45, and basic conditions of the operator 45 such as an hourly unit price. Further, as shown in FIG. 2, the operator database 32 includes a plurality of databases 321, 322, 323 that manage different information. In the example shown in FIG. 2, the operator database 32 includes the driving characteristic database 321, the evaluation database 322, and the management database 323.

FIG. 3 is a diagram for explaining an outline of the driving characteristic database 321. The driving characteristic database 321 is a database that stores the driving characteristics for each of the operators 45. In the example shown in FIG. 3, a feature amount of each the operators 45 of four people A, B, C, and D are represented by a numerical value in five stages, for five driving characteristics that are a steering wheel operation (steering operation), a braking operation, an accelerating operation, a communication delay robustness, and a safety score. The value of each of the feature amounts is periodically updated based on the monitor result of the remote driving of the operator 45.

In the example shown in FIG. 3, each of the feature amounts of the steering wheel operation, the braking operation, and the accelerating operation is, for example, a numerical value that is larger as the operation is abrupt and smaller as the operation is gentle. The robustness regarding communication delay means the ability of the operator 45 to respond to the communication delay. For example, in the case where a deflection width of the handle is 5 degrees and the case where the deflection width is 1 degree with a communication delay of 100 ms, it can be said that the swing width of 1 degree is more robust. For each of the feature amounts of robustness regarding communication delay, for example, the higher the robustness, the larger the numerical value, and the lower the robustness, the smaller the numerical value. The safety score is a numerical value determined from a driving history of the operator 45 so far, and for example, the higher the ratio of the period during which safe driving is performed in the entire operating period, the larger the numerical value.

When the operator condition is selected in the switching request of the occupant 25 and the selected operator condition includes the driving characteristic, the operator selection unit 33 refers to the driving characteristic database 321. For example, in the example shown in FIG. 3, when the current operator 45 is the operator D and the occupant 25 wants a gentler steering wheel operation in the switching request, the operator B is selected as the new operator 45. Further, when the current operator 45 is the operator B, when the occupant 25 wants a gentler braking operation and higher robustness regarding communication delay in the switching request, the operator C is selected as the new operator 45.

In addition, the case where the operator condition is selected in the switching request of the occupant 25 but the driving characteristic is not selected is the case in which only the basic condition such as the operation history and the hourly unit price of the operator 45 are selected. In this case, the operator selection unit 33 searches the operator database 32 using the basic condition selected in the switching request as a key, and selects the new operator 45 from the search results.

FIG. 4 is a diagram for explaining an outline of the evaluation database 322. The evaluation database 322 is a database in which a result of an evaluation of each of the operators 45 by each of the occupants 25 is accumulated. In the example shown in FIG. 4, the evaluation results are represented by the evaluation values regarding the five occupants 25 that are I, II, III, IV, and V for the four operators 45 that are A, B, C, and D. The larger the evaluation value, the higher the evaluation by the occupant 25 regarding the operator 45. A cell in which the evaluation value is blank means that the operator 45 corresponding to the cell has never been in charge of the occupant 25 corresponding to the cell in the past. For example, the operator A has never been in charge of the occupant IV. The evaluation value of each of the cells is updated every time the occupant 25 inputs the evaluation result.

When the operator condition is not selected in the switching request of the occupant 25, the operator selection unit 33 refers to the evaluation database 322. By referring to the evaluation database 322, it is possible to know which operator 45 is highly evaluated by the occupant 25. The fact that the occupant 25 does not select the operator condition in the switching request means that the occupant 25 wants the current operator 45 to be replaced by the operator more suitable for their preference, that is, the operator 45 having a higher evaluation, compared to the current operator 45. That is, when the operator condition is not selected in the switching request, it can be said that the switching request includes the operator 45 having a higher evaluation value as an implicit operator condition.

The selection of the operator 45 with reference to the evaluation database 322 will be described with reference to specific examples. For example, in the example shown in FIG. 4, when the current operator 45 of the occupant IV is the operator B, the operator C is selected as the new operator 45. Further, when the current operator 45 of the occupant II is the operator C, the operator B having a higher evaluation value among the operator A and the operator B is selected as the new operator 45. Similarly, when there multiple candidates for the new operator 45 searched with the operator condition, the operator 45 to which a higher evaluation value is given is selected in the evaluation database 322.

Here, the focus will be on the occupant I and the occupant III. The operator B is the only operator 45 who has been in charge of the occupant I in the past. Therefore, when the current operator 45 of the occupant I is the operator B, the operator 45 capable of responding to the switching request of the occupant I cannot be found from the past evaluation results of the occupant I. In this case, the operator selection unit 33 first identifies the occupant (similar occupant) who has requested the operator condition most similar to the operator condition requested by the occupant I (or the operator condition requested in the past) from the history of the past switching request. Here, the occupant IV is the similar occupant. The operator selection unit 33 searches the evaluation database 322 for the operator 45 having the highest evaluation by the occupant IV who is the similar occupant, and selects the operator C obtained by the search as the new operator 45 for the occupant I.

On the other hand, there is no operator 45 who has been in charge of the occupant III in the past. This means that occupant III is a new user of the new remote driving system 10. In this case, the history of past switching requests of the occupant III cannot be used. Thus, when the switching request is received from the occupant III, the operator selection unit 33 selects the operator 45 having the highest evaluation of the occupant 25 among the waiting operators 45. For example, when the current operator 45 of the occupant III is the operator A and the operators B, C, and D are waiting, the operator B having the highest average evaluation value is selected as the new operator 45.

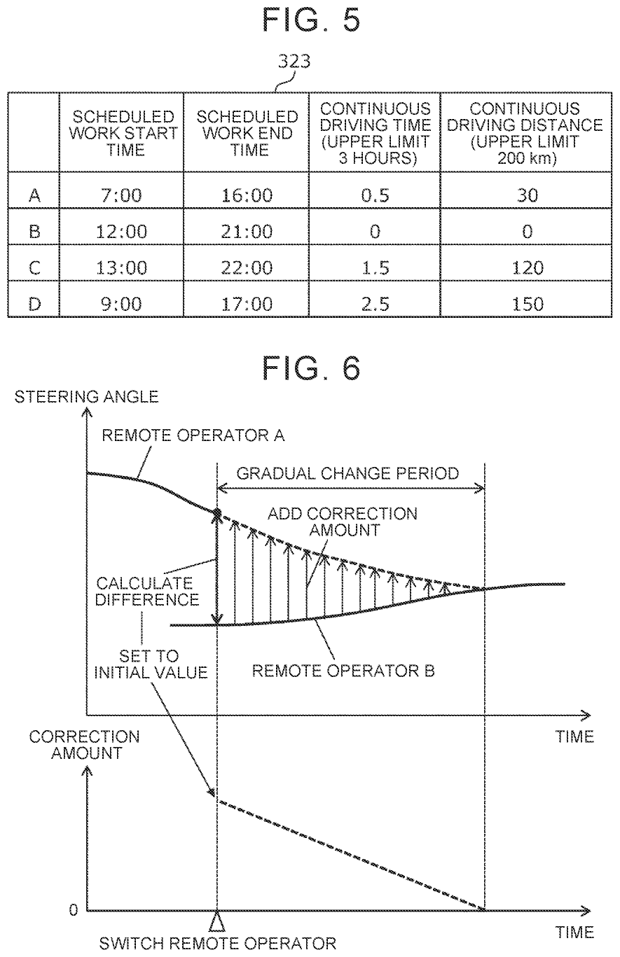

FIG. 5 is a diagram for explaining an outline of the management database 323. The management database 323 is a database that manages working conditions for each of the operators 45. In the example shown in FIG. 5, a scheduled work start time, a scheduled work end time, a continuous operation time, and a continuous operation distance are recorded for each of the four operators 45 that are A, B, C, and D. The scheduled work start time and the scheduled work end time are registered values registered in advance. The continuous operation time and the continuous operation distance are count values for in which counting starts when the remote driving starts and that are reset when the remote driving ends. An upper limit is set for each of the continuous operation time and the continuous operation distance in consideration of fatigue and deterioration of concentration of the operator 45 due to long-time operation.

The operator selection unit 33 refers to the management database 323 in combination with the driving characteristic database 321 or in combination with the evaluation database 322. In the example shown in FIG. 5, when the current time is 12:30, the operator C whose work has not started cannot be selected. Further, when the current time is 15:00 and the expected driving end time is 2 hours and 30 minutes later, the selectable operator 45 is the operator B or the operator C. When the candidates of the new operator 45 selected from the driving characteristics and the evaluation value are the operator C and the operator D, the new operator 45 is narrowed down to the operator C by referring to the working conditions.

3. Operator Switching Process

Next, the details of the operator switching process that is performed when the operator 45 is switched will be described with reference to FIGS. 6 to 8. There are roughly two methods for the operator switching process. The first method is a method of gradually changing the operation amount for the vehicle 2 from the operation amount by the current operator 45 to the operation amount by the new operator 45. Specifically, it is a method in which the operator 45 is replaced in response to the switching request, and then the difference in the operation amount between the operators that occurs when the operator 45 is switched is gradually eliminated after switching is performed. The first method includes a correction amount gradual changing method and a correction gain correction method.

FIG. 6 is a diagram illustrating an operator switching process by the correction amount gradual changing method. The correction amount gradual changing method is a method particularly suitable for switching the steering angle, among the operation amounts for the vehicle 2. However, it can also be used to switch the amount of brake depression and the amount of accelerator depression. In the example shown in FIG. 6, the predecessor operator 45 is the operator A, and the successor operator 45 is the operator B. The operation amount that can be switched is the steering angle.

In the correction amount gradual changing method, the difference between the steering angle by the operator A and the steering angle by the operator B at the time of switching to the operator B is set as the initial value of the correction amount. After the switch to the operator B, the value obtained by adding the correction amount to the steering angle by the operator B is used as the steering angle for the vehicle 2. That is, the difference between the steering angle by the operator A and the steering angle by the operator B that occurred when switching is performed is handed over to the succeeding operator B. The correction amount is gradually reduced as shown in the lower graph of FIG. 6, and is reduced to zero after a predetermined time from when the operator A is switched to the operator B. As a result, the steering angle with respect to the vehicle 2 can be gradually changed from the steering angle by the operator A to the steering angle by the operator B, and the wobbling of the vehicle 2 due to the sudden change in the steering angle when the operator is switched can be suppressed. As the correction amount is gradually reduced, the steering angle with respect to the vehicle 2 may be excessive or insufficient, and a deviation may occur between a locus of the vehicle 2 and a target locus. However, when the operator B naturally corrects the steering angle, the deviation of the trajectory of the vehicle 2 is eliminated.

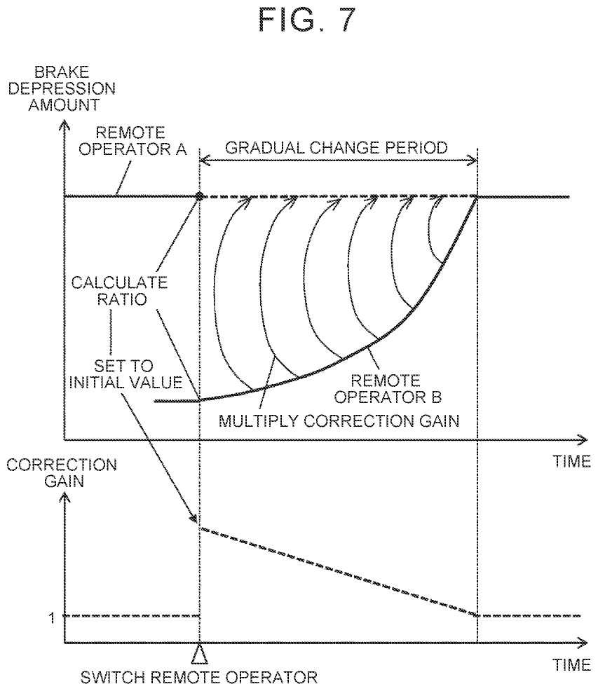

FIG. 7 is a diagram illustrating an operator switching process by the correction gain gradual change method. The correction gain gradual change method is a method particularly suitable for switching between the brake depression amount and the accelerator depression amount, among the operation amounts for the vehicle 2. In the example shown in FIG. 7, the predecessor operator 45 is the operator A, and the successor operator 45 is the operator B. The operation amount that can be switched is the depression amount of the brake.

In the correction gain gradual change method, the ratio of the brake depression amount by the operator A and the brake depression amount by the operator B at the time of switching to the operator B is set as the initial value of the correction gain. After the operator A is switched to the operator B, the value obtained by multiplying the brake depression amount by the operator B and the correction gain is used as the brake depression amount for the vehicle 2. The correction gain is gradually reduced as shown in the lower graph of FIG. 7, and is set to the basic value of 1 after a predetermined time from when the operator A is switched to the operator B. As a result, the brake depression amount for the vehicle 2 can be gradually changed from the brake depression amount by the operator A to the brake depression amount by the operator B, and the sudden change of the deceleration of the vehicle 2 due to the sudden change in the brake depression amount when the operator is switched can be suppressed. As the correction gain is gradually reduced, the amount of brake depression with respect to the vehicle 2 may be excessive or insufficient, and the deceleration of the vehicle 2 may be excessive or insufficient. However, when the operator B naturally corrects the depression amount of the brake, the excess or deficiency of deceleration is eliminated.

The second method of the operator switching process is a method of executing the switch of the operator 45 after waiting for the difference between the operation amount by the new operator 45 and the operation amount by the current operator 45 to be a predetermined value or less. Specifically, in the second method, the operation amount for the vehicle 2 is switched from the operation amount by the current operator 45 to the operation amount by the new operator 45 in response to the fact that the difference between the two is within the threshold value.

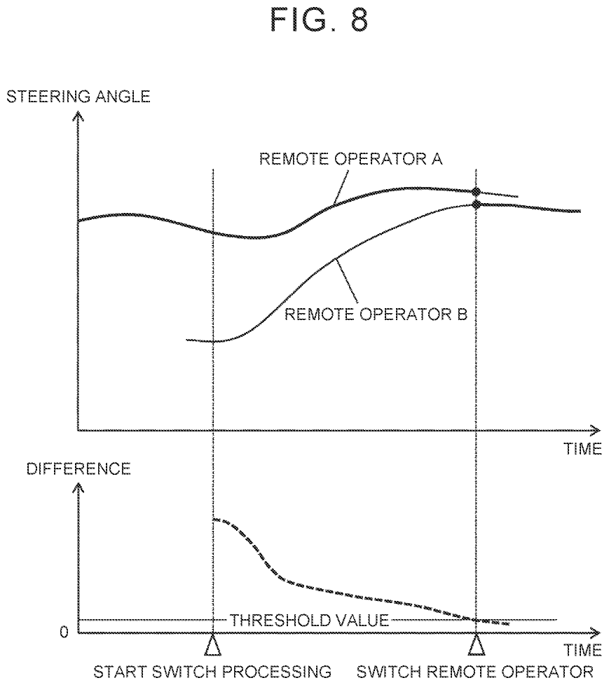

FIG. 8 is a diagram illustrating an operator switching process according to the second method. The second method is a method particularly suitable for switching the steering angle, among the operation amounts for the vehicle 2. In the example shown in FIG. 8, the predecessor operator 45 is the operator A, and the successor operator 45 is the operator B. The operation amount that can be switched is the steering angle.

In the second method, after the start of the switching process, the difference between the steering angle by the operator A and the steering angle by the operator B is calculated. The operator B operates the steering wheel so as to reduce this difference. That is, in the second method, the successor operator B operates the steering wheel so that the steering angle is adjusted to the steering angle by the predecessor operator A. Then, when the difference between the steering angle by the operator A and the steering angle by the operator B becomes equal to or less than the threshold value, the operator 45 is replaced. As a result, the steering of the vehicle 2 is smoothly handed over from the steering by the operator A to the steering by the operator B. In the second method, the steering angle by the predecessor operator A is used as the steering angle for the vehicle 2 until switching is performed, and after switching is performed, the steering angle by the successor operator B is used as the steering angle for the vehicle 2 as it is.

4. Remote Driving Handing Over Method

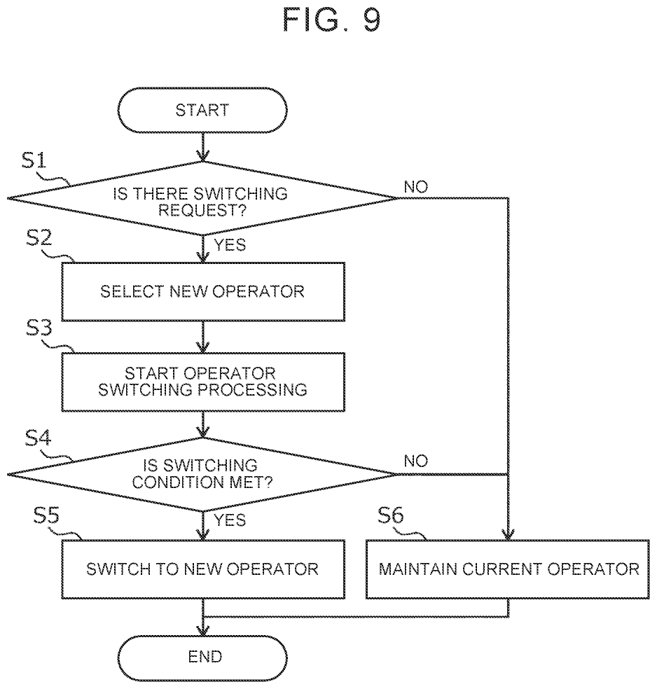

As described above, in the remote driving system 10, the operator 45 is replaced in response to the switching request from the occupant 25. That is, in the remote driving system 10, the remote driving of the vehicle 2 can be handed over to another operator 45. FIG. 9 is a flowchart showing a remote driving handing over method executed by the remote driving system 10. Hereinafter, a remote driving handing over method according to the present embodiment will be described with reference to the flowchart.

In step S1, it is determined whether there is the switching request from occupant 25. When there is no switching request, the process proceeds to step 6 and the current remote driving by the operator 45 is maintained. When there is a switching request, the process proceeds to step 2.

In step S2, the new operator 45 that meets the operator conditions required by the occupant 25 is selected from the waiting operators 45. The new operator 45 is selected by the method described in “2. Operator Selection”. However, as another method, a method of randomly selecting the new operator 45 from the waiting operators 45 can also be used.

In step S3, the switching process for the new operator 45 selected in step S2 is started. The switching process is performed by the method described in “3. Operator Switching Process”.

In step S4, it is determined whether the switching condition of the operator 45 is satisfied. The switching condition of the operator 45 differs depending on whether the operator switching process is the first method or the second method. When the first method is performed as the switching process of the operator 45, the fact that the difference (in the case of the correction amount gradual changing method) or the ratio (in the case of the correction gain gradual change method) between the operation amount by the current operator 45 and the operation amount by the new operator 45 is less than or equal to the predetermined value is the switching condition. When the second method is performed as the switching process of the operator 45, it is determined that the switching condition is not satisfied when the elapsed time from the start of the switching process exceeds a predetermined time.

As a result of the determination in step S4, When the switching condition is satisfied, the process proceeds to step S5, and when the switching condition is not satisfied, the process proceeds to step S6. In step S5, switching to the new operator 45 is executed. On the other hand, in step S6, remote driving by the current operator 45 is maintained, and switching to the new operator 45 is temporarily postponed. Eventually, when the switching condition is satisfied, switching to the new operator 45 is executed.

As described above, according to the remote driving handing over method of the present embodiment, when the occupant 25 requests the operator 45 to be switched, the remote driving of the vehicle 2 can be handed over to the remote driving by another operator 45 without delay.

5. Other Embodiments

In the above embodiment, the switching request is issued by the occupant 25. However, when there is an observer who monitors the operation of the operator 45, the observer may issue the switching request at the discretion of the observer. An example of a case where the switching request is issued by the observer may be the case where the observer detects a fluctuation in the steering operation of the operator 45 or a decrease in attention. The observer may be a person or a device having a determination function.

Further, the control center 3 may generate the switching request internally. For example, when the continuous operation time of the operator 45 reaches the upper limit time, or when the continuous operation distance reaches the upper limit distance, the switching request may be generated in order to switch the operator 45. The upper limit time and the upper limit distance are specified values for ensuring safe remote driving. In the example shown in FIG. 5, the operator D has already continued remote driving for 2.5 hours in terms of time and 150 km in distance. Eventually, when the continuous operation time reaches the upper limit of 3 hours or the continuous operation distance reaches the upper limit of 200 km, the switching request for changing the operator D is issued.

Further, the switching request may be issued from the operator 45 itself during remote driving. An example of the case where the operator 45 itself issues the switching request includes, for example, the case where the physical condition becomes bad during the remote driving or the case where a restroom break is required.

When the change of the operator 45 is performed regardless of the intention of the occupant 25 as in the above example, it is preferable to inform the occupant 25 in advance that switching of the operator 45 will be performed.

Regarding the operation amount and set value of safety equipment such as a light and comfort equipment such as an air conditioner, it is preferable to succeed the operation amount and set value by the predecessor even after switching of the operator 45 is performed.

What is claimed is:

1. A remote driving handing over method of a vehicle, the remote driving handing over method comprising:
acquiring a switching request;
selecting a new remote operator in charge of remote driving of the vehicle, in response to the switching request; and
switching a person in charge of remote driving of the vehicle from a current remote operator to the new remote operator in response to selection of the new remote operator.

2. The remote driving handing over method according to claim 1, wherein selecting the new remote operator includes selecting a remote operator that meets an operator condition required by an occupant of the vehicle.

3. The remote driving handing over method according to claim 2, wherein selecting the remote operator that meets the operator condition required by the occupant includes referring to a driving characteristic database that stores a driving characteristic of each of the remote operators.

4. The remote driving handing over method according to claim 3, wherein the driving characteristic includes a feature amount of at least one driving operation among a steering operation, a braking operation, and an accelerating operation.

5. The remote driving handing over method according to claim 3, wherein the driving characteristic includes a robustness of a driving operation regarding a communication delay.

6. The remote driving handing over method according to claim 2, wherein selecting the remote operator that meets the operator condition required by the occupant includes referring to an evaluation database in which a result of an evaluation of each of the remote operators by each of the occupants is accumulated.

7. The remote driving handing over method according to claim 6, wherein referring to the evaluation database includes searching for a remote operator having the highest evaluation by the occupant among remote operators who have been in charge of the occupant, from the evaluation database.

8. The remote driving handing over method according to claim 7, wherein referring to the evaluation database includes searching, from the evaluation database, for a remote operator having the highest evaluation by an occupant who requests an operator condition closest to the operator condition requested by the occupant, in response to an absence of the remote operator who was in charge of the occupant in the past.

9. The remote driving handing over method according to claim 2, wherein selecting the remote operator that meets the operator condition required by the occupant includes referring to a management database that manages a working condition of each of the remote operators.

10. The remote driving handing over method according to claim 1, wherein selecting the new remote operator includes selecting a remote operator having the highest evaluation by an entirety of users including an occupant of the vehicle among remote operators on standby.

11. The remote driving handing over method according to claim 2, wherein acquiring the switching request includes acquiring a switching request issued by the occupant or a switching request issued by an observer who observes driving of the current remote operator.

12. The remote driving handing over method according to claim 2, wherein acquiring the switching request includes acquiring, as the switching request, a fact that a driving time or a driving distance of the current remote operator has reached a specified value.

13. The remote driving handing over method according to claim 2, wherein acquiring the switching request includes acquiring a switching request issued by the current remote operator.

14. The remote driving handing over method according to claim 2, wherein switching the person in charge of remote driving of the vehicle from the current remote operator to the new remote operator includes gradually changing an operation amount of the vehicle from an operation amount by the current remote operator to an operation amount by the new remote operator.

15. The remote driving handing over method according to claim 14, wherein gradually changing an operation amount of the vehicle includes gradually decreasing a correction amount of the operation amount by the new remote operator, in which a difference between the operation amount by the current remote operator and the operation amount by the new remote operator when switching to the new remote operator is set as an initial value.

16. The remote driving handing over method according to claim 14, wherein gradually changing an operation amount of the vehicle includes gradually decreasing a correction gain of the operation amount by the new remote operator, in which a ratio between the operation amount by the current remote operator and the operation amount by the new remote operator when switching to the new remote operator is set as an initial value.

17. The remote driving handing over method according to claim 2, wherein switching the person in charge of remote driving of the vehicle from the current remote operator to the new remote operator includes switching an operation amount of the vehicle from an operation amount by the current remote operator to an operation amount by the new remote operator, in response to a fact that a difference between the operation amount by the new remote operator and the operation amount by the current remote operator has become a predetermined value or less.

18. The remote driving handing over method according to claim 1, further comprising extending remote driving by the current remote operator in response to a fact that a switching condition of switching from the current remote operator to the new remote operator is not met.

19. A remote driving system of a vehicle, the remote driving system comprising:
at least one memory that stores at least one program; and
at least one processor connected to the at least one memory,
wherein the at least one program causes the at least one processor to execute
acquiring a switching request,
selecting a new remote operator in charge of remote driving of the vehicle, in response to the switching request, and
switching a person in charge of remote driving of the vehicle from a current remote operator to the new remote operator response to selection of the new remote operator.

20. A non-transitory storage medium that stores a program that causes a computer to hand over remote driving of a vehicle, wherein the program causes the computer to execute:
acquiring a switching request;
selecting a new remote operator in charge of remote driving of the vehicle, in response to the switching request; and
switching a person in charge of remote driving of the vehicle from a current remote operator to the new remote operator in response to selection of the new remote operator.
